(19) United States
(12) Patent Application Publication
(10) Pub. No.: US 2025/0055816 A1
(43) Pub. Date: Feb. 13, 2025

(54) METHOD, TERMINAL, AND SERVER FOR PROVIDING REACTION SET FOR CONTENT

(71) Applicant: KAKAO CORP., Jeju-si (KR)

(72) Inventors: Bo Hyeon LIM, Seongnam-si (KR); Ji Hyune SIM, Seongnam-si (KR)

(21) Appl. No.: 18/782,585

(22) Filed: Jul. 24, 2024

(30) Foreign Application Priority Data
Aug. 11, 2023 (KR) 10-2023-0105439

(51) Int. Cl. H04L 51/04; H04L 51/10

(52) U.S. Cl. CPC H04L 51/04; H04L 51/10

(57) ABSTRACT

Proposed is a method for providing a reaction set for content by a server. The method may include receiving first reaction custom information for a first chat room from a first terminal, and generating a first reaction set including at least one reaction information item selected based on the first reaction custom information. The method may also include in response to a second terminal entering the first chat room, providing the second terminal with at least one first content posted in the first chat room and a first reaction set corresponding to each of the at least one first content. The method may further include receiving selection information on a reaction information item included in the first reaction set from the second terminal.

### CROSS REFERENCE TO RELATED APPLICATION

This application claims the benefit of Korean Patent Application No. 10-2023-0105439 filed on Aug. 11, 2023, the contents of which are all hereby incorporated by reference herein in their entirety.

### BACKGROUND

### Technical Field

The present disclosure relates to a method of providing a reaction set for content in a chat room.

### Description of Related Technology

Due to the proliferation of portable mobile devices and the development of wireless communication technology, chat services that enable the real-time transmission and reception of instant messages are widely used. Although traditional chat services primarily focused on transmitting chat messages between two users, recent chat services allow multiple users to participate in a single chat room and offer various additional functions such as the feature to send different types of content, including images and multimedia content, through a chat room.

### SUMMARY

The present disclosure provides a method for providing a custom reaction set of a chat room by a server to a terminal entering the chat room.

The present disclosure also provides a method for conveniently selecting a reaction information item by a terminal entering a chat room.

In one general aspect, there is provided a method for providing a reaction set for content by a server, the method including: receiving first reaction custom information for a first chat room from a first terminal; generating a first reaction set including at least one reaction information item selected based on the first reaction custom information; in response to a second terminal entering the first chat room, providing the second terminal with at least one first content posted in the first chat room and a first reaction set corresponding to each of the at least one first content; and receiving selection information on a reaction information item included in the first reaction set from the second terminal.

The method may further include: receiving second reaction custom information for a second chat room from the first terminal; generating a second reaction set including at least one reaction information item selected based on the second reaction custom information, where each of the first and second reaction sets includes a distinct combination of reaction information items; in response to the second terminal entering the second chat room, providing the second terminal with at least one second content posted in the second chat room and a second reaction set corresponding to each of the at least one second content; and receiving selection information on a reaction information item included in the second reaction set from the second terminal.

The method may further include, in response to the second terminal entering a third chat room when no separate reaction custom information for the third chat room is received from the first terminal, providing the second terminal with at least one third content posted in the third chat room and a default reaction set corresponding to each of the at least one third content.

Providing the first or second reaction set may include: providing the second terminal with count information and an extension interface for at least one reaction information item included in the first or second reaction set, wherein the count information indicates information on a number of times a user has selected the reaction information item; and in response to receiving an interaction with the extension interface from the second terminal, providing a reaction interface including entire reaction information items included in the first or second reaction set.

The count information may be provided only for a reaction information item of which a count satisfies a predetermined criterion among the reaction information items included in the first or second reaction set.

The selection information may be generated in response to an interaction received by the second terminal with at least one of the count information and the reaction interface.

The method may further include generating a 1a-th reaction set including at least one of the reaction information items included in the first reaction set. The server may provide the second terminal with first and second paths to enter the first chat room. In providing the first reaction set, the first reaction set may be provided to the second terminal when the second terminal enters the first chat room through the first path, and the 1a-th reaction set instead of the first reaction set may be provided to the second terminal when the second terminal enters the first chat room through the second path.

The first and second paths may correspond to entries via different applications installed on the second terminal.

At least one of the reaction information items included in the first and second reaction sets may be generated based on graphic information received by the server from the first terminal.

The first and second chat rooms may belong to a same chat room group, and the first terminal may correspond to an administrator terminal for the chat room group.

The method may further include, immediately after receiving the selection information, providing second terminal with guidance information on joining the chat room group when the second terminal belongs to a user who has not joined the chat room group.

In another aspect, there is provided a server for providing a reaction set for content, the server including a memory storing instructions, and a processor configured to execute the instructions to receive first reaction custom information for a first chat room from a first terminal; generate a first reaction set including at least one reaction information item selected based on the first reaction custom information; in response to a second terminal entering the first chat room, provide the second terminal with at least one first content posted in the first chat room and a first reaction set corresponding to each of the at least one first content; and receive selection information on a reaction information item included in the first reaction set from the second terminal.

In yet another aspect, there is provided a method for displaying a reaction set for content by a terminal, the method including: requesting the server to view a first chat room; displaying at least one first content posted in the first chat room and a first reaction set corresponding to each of the at least one first content, the first reaction set including at least one reaction information item; requesting the server to view a second chat room; displaying at least one second content posted in the second chat room and a second reaction set corresponding to each of the at least one second content, the second reaction set including at least one reaction information item; and providing the server with selection information on a reaction information item included in the first or second reaction set. Different combination of reaction information items may be included in the first and second reaction sets.

Displaying the first or second reaction set may include displaying count information and an extension interface for at least one of the reaction information items included in the first or second reaction set, wherein the count information may be information on a number of times a user has selected the reaction information item; and in response to receiving an interaction with the extension interface, displaying a reaction interface including entire reaction information items included in the first or second reaction set.

The count information may be provided only for a reaction information item of which a count satisfies a predetermined criterion among the reaction information items included in the first or second reaction set.

The selection information may be generated in response to an interaction with at least one of the count information and the reaction interface.

In requesting to view the first chat room, the terminal may request to view the first chat room through any one of first and second paths. In displaying the first reaction set, the first reaction set may be displayed when the terminal requests to view the first chat room through the first path, and a 1a-th reaction set including at least one of the reaction information items included in the first reaction set may be displayed instead of the first reaction set when the terminal requests to view the first chat room through the second path.

In yet another aspect, there is provided a terminal for displaying a reaction set for content, the terminal including a memory storing instructions and a processor configured to execute the instructions to: request the server to view a first chat room; display at least one first content posted in the first chat room and a first reaction set corresponding to each of the at least one first content, the first reaction set including at least one reaction information item; requesting the server to view a second chat room; display at least one second content posted in the second chat room and a second reaction set corresponding to each of the at least one second content, the second reaction set including at least one reaction information item; and provide the server with selection information on a reaction information item included in the first or second reaction set. Different combination of reaction information items may be included in the first and second reaction sets.

### BRIEF DESCRIPTION OF THE DRAWINGS

FIG. 1 is a diagram illustrating an example of a network environment according to an embodiment of the present disclosure.

FIG. 2 is a flowchart for explaining a method for providing a reaction set for content by a server of the present disclosure.

FIG. 3 is a flowchart for explaining several steps included in a method for providing a reaction set for content by a server of the present disclosure.

FIGS. 4 to 9 illustrate screens related to implementing a method for providing a reaction set for content by a server of the present disclosure.

FIG. 10 is a flowchart for explaining a method for providing a reaction set for content by a terminal of the present disclosure.

### DETAILED DESCRIPTION

With the emphasis on social networking among users in chat rooms, some chat services provide a reaction function for messages in chat rooms. The reaction function allows a user who has viewed a message in a chat room to leave a reaction corresponding to the message by selecting an emoji or icon that representing the user's emotions, response, or evaluation.

Recently, various methods have been attempted to reflect a wider range of a user's emotions, responses, and evaluations while allowing the user to conveniently leave a reaction.

Hereinafter, embodiments of the disclosure will be described in detail with reference to the attached drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

As used herein, the singular forms “a”, “an,” and “the” are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

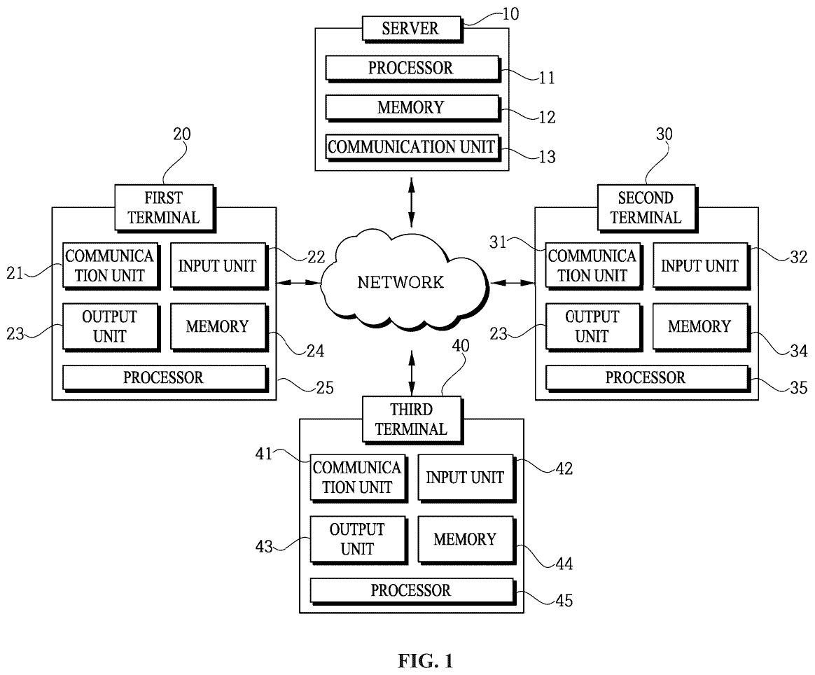

FIG. 1 is a diagram illustrating an example of a network environment according to an embodiment of the present disclosure.

A network environment according to an embodiment of the present disclosure shown in FIG. 1 may include a server 10 and a terminal. The terminal may include at least one terminal connected to the server 10 over a network. In FIG. 1, a first terminal 20, a second terminal 30, and a third terminal 40 are shown as examples of the terminal.

The first user terminal 20 refers to a terminal that a first user logs into with the first user's account registered on the server 10, and the second user terminal 30 refers to a terminal that a second user logs into with the second user's account registered on the server 10, and the third user terminal 40 refers to a terminal that a third user logs into with the third user's account registered on the server 10.

Hereinafter, for the convenience of explanation, the first terminal 20 will be described as an administrator terminal of a chat room or chat room group, and the second and third terminals 30 and 40 will be described as terminals that view chat rooms managed by the first terminal 20. However, the present disclosure is not intended to specify or limit the functions that can be performed by the terminal.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be a device capable of transmitting and receiving information through communication with a terminal over a network. The server 10 may be implemented as a single computer device or a plurality of computer devices providing commands, codes, files, content, services, etc.

The server 10 may include a processor 11, a memory 12, and a communication unit 13.

The processor 11 controls the overall operation of the memory 12 and the communication unit 13 to provide a chat service to the terminal. Specifically, the processor 11 provides the terminals 20, 30, and 40 with functions of creating a chat room or chat room group in the terminals 20, 30, and 40 and generating a reaction set based on reaction custom information.

The memory 12 functions as a storage medium and may store a number of application programs running on the server 10, and data and commands for operation of the server 10. In one embodiment, an application for providing the above-described chat service may be stored in the memory 12.

The memory 12 may be provided in the form of any of various hardware storage devices such as an ROM, an RAM, a flash drive, a hard drive, etc. or may be provided in the form of web storage.

The communication unit 13 may communicate with a terminal in a wired/wireless manner over a network.

The server 10 of the present disclosure may provide a chat service to terminals. Specifically, the server 10 provides the terminals 20, 30, and 40 with the functions of creating a chat room or chat room group and generating a reaction set based on custom reaction information.

The server may receive first custom reaction information for a first chat room and second custom reaction information for a second chat room from the first terminal 20, and generate first and second reaction sets, each including at least one reaction information item selected based on a corresponding one of the first and second custom reaction information. Here, the first and second reaction sets may include different combinations of reaction information items. When the second terminal 30 enters the first chat room, the server 10 may provide the second terminal 30 with at least one first content posted in the first chat room and the first reaction set corresponding to each of at least one first content. When the second terminal 30 enters the second chat room, the server 10 may provide the second terminal 30 with at least one second content posted in the second chat room and the second reaction set corresponding to each of at least one second content. Thereafter, the server 10 may receive selection information on a reaction information item included in the first or second reaction set from the second terminal 30.

Here, each reaction information item refers to information on a response input by a user who has viewed content. After viewing the content, the user may input a reaction information item that expresses any of various emotions, evaluations, or responses to the content. This reaction information item may be transmitted to the server 10, and count information for the reaction information item may be provided for other users to view.

Here, the count information for the reaction information item refers to the number of times the user who has viewed the content has left reactions. The server 10 may receive the user's selection information on a reaction information item from the user's terminal and may calculate count information for the reaction information item based on the number of times the selection information is received.

Here, a reaction set refers to a set of reaction options allowed for a user to select when inputting a reaction after viewing content. The reaction set may include at least one reaction information item that can be selected by a user who has viewed the content. The server 10 may provide a reaction set to a terminal of the user viewing the content, allowing the user to select at least one reaction information item included in the reaction set.

In the present disclosure, the reaction set may be set to be a custom reaction set or a default reaction set. The custom reaction set refers to a reaction set including at least one reaction information item selected based on a setter's intention. The setter may create a custom reaction set by selecting at least one reaction information item from a plurality of reaction information items provided by the server 10 based on the setter's preferences, likes, or determination. The custom reaction set may include distinct reaction information items depending on the setter's choices, so each custom reaction set may have a distinct combination of reaction information.

Here, the setter of the custom reaction set may be the administrator (operator) of the chat room or chat room group or the administrator (operator) of the chat service provided by the server 10. The criteria for becoming the setter of a custom reaction set may vary depending on the policies of the chat service. For convenience of explanation, the administrator and operator will not be separately distinguished hereinafter and will be collectively referred to as the administrator.

A default reaction set refers to a reaction set that includes predetermined reaction information items, irrespective of the setter's intention. If no separate custom reaction information for a specific chat room is received from the setter, the server 10 may set a reaction set provided through the specific chat room as the default reaction set.

Here, the reaction custom information refers to information input by the setter to generate the above-described custom reaction set. The server 10 may provide a custom reaction interface to the setter's terminal to allow the setter to select a reaction information item to include in a custom reaction set. The setter may receive a list of any selectable reaction information items through the custom reaction interface and select each individual reaction information item to include in the custom reaction set. The setter's terminal may generate custom reaction information based on the setter's selection of individual reaction information and transmit the generated custom reaction information to the server 10. The server 10 may generate a custom reaction set based on the custom reaction information received from the setter's terminal.

Here, selection information on a reaction refers to information indicating that a user who has viewed the content has selected at least one reaction information item to leave a reaction to the content.

The terminals 20, 30, and 40 include a first terminal 20, which is an administrator terminal of a chat room or chat room group, and second and third terminals 30 and 40 which are viewer terminals of the chat room.

The terminals 20, 30, and 40 may include communication units 21, 31, and 41, input units 22, 32, and 42, output units 23, 33, and 43, memories 24, 34, and 44, and processors 25, 35, and 45.

The communication units 21, 31, and 41 may communicate with the server 10 or other terminals in a wired or wireless manner.

The input units 22, 32, and 42 may receive various information through a user's operation and input. Each of the input units 22, 32, and 42 may be a touch screen module, a keyboard, a mouse, a button, a camera, stylus, a microphone, etc.

The terminals 20, 30, and 40 may receive users' interactions through the input units 22, 32, and 42. An interaction refers to a user operating an input unit to input information reflecting the user's selection or intention into a terminal. For example, the interaction may include touching on a touchscreen, clicking with a mouse, typing on a keyboard, providing voice input through a microphone, capturing an image using a camera, recognizing movements through a motion sensor, and the like.

The output units 23, 33, and 43 may output various information. The output units 23, 33, and 43 may be display devices, speakers, vibration generators, tactile generators, etc. In some cases, each of the output units 23, 33, and 43 may be a device (e.g., Bluetooth earphone) that is connected to the terminals 10 and 20 through wired or wireless communication (e.g., short-range radio communication such as Bluetooth) to receive and output signals.

Each of the memories 24, 34, and 44 function as a storage medium and may store a plurality of application programs running on the terminals 20, 30, and 40 and data and instructions for operating the terminals 20, 30, and 40. Each of the memories 24, 34, and 44 may be provided in the form of any of various hardware storage devices such as an ROM, an RAM, a flash drive, a hard drive, etc. or may be provided in the form of web storage.

In one embodiment, an application for providing a chat service may be stored in the memories 24, 34, and 44.

The processors 25, 35, and 45 may execute an application associated with a messenger service by controlling the overall operation of the communication units 21, 31, and 41, the input units 22, 32, and 42, the output units 23, 33, and 43, and the memories 24, 34, and 44.

The first terminal 20 corresponds to an administrator terminal of a chat room or chat room group. The administrator of a chat room or chat room group is one of the users of the chat service provided by the server 10, and this user may have the authority to create, manage, or operate a chat room or chat room group. In some cases, the administrator of the chat room or chat room group may be an administrator who manages or operates the chat service provided by the server 10.

The first terminal 20 may transmit custom reaction information on a chat room to the server 10 to generate a custom reaction set. The first terminal 20 may add or delete a reaction information item from the generated custom reaction set or change the order of reaction information items.

By requesting the server 10 to view a first chat room, the second terminal 30 may display at least one first content posted in the first chat room and a first reaction set corresponding to each of at least one first content. Also, by requesting the server 10 to view a second chat room, the second terminal 30 may display at least one second content posted in the second chat room and a second reaction set corresponding to each of at least one second content. Here, each of the first and second reaction sets may include at least one reaction information item. The second terminal 30 may provide the server 10 with selection information on an reaction information item included in the first or second reaction set. Here, each of the first and second reaction sets may include a distinct combination of reaction information items.

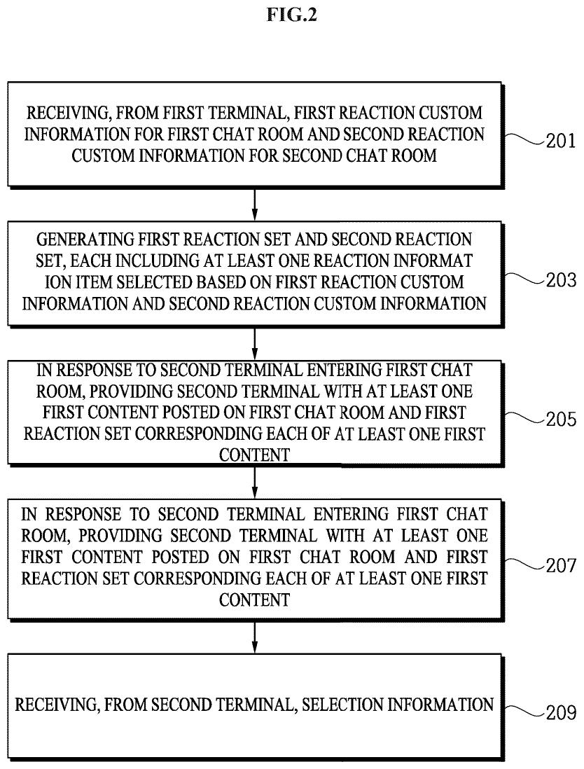

Hereinafter, a method for providing a reaction set for content by the server 10 of the present disclosure will be described with reference to FIGS. 2 to 9.

FIG. 2 is a flowchart for explaining a method for providing a reaction set for content by the server 10 of the present disclosure.

Referring to FIG. 2, a method of providing a reaction set for content, performed between a server 10 and first and second terminals 20 and 30, will be described.

In operation 201, the server 10 receives first reaction custom information and second reaction custom information from the first terminal 20.

The first reaction custom information may correspond to a first chat room, and the second reaction custom information may correspond to a second chat room.

Here, the first chat room and the second chat room may belong to one chat room group. The server 10 may provide services related to a chat room group including at least one chat room. Chat rooms belonging to the same chat room group may share a common topic, subject, purpose, or theme. For example, a chat room group with the theme “Real-time Weather” may be created, and multiple chat rooms related to individual topics, such as “National Weather,” “Seoul Weather,” and “Incheon Weather,” may belong to the chat room group.

The first terminal 20 may correspond to an administrator terminal of the chat room group. Specifically, the first terminal 20 may belong to a user who created the chat room group, a user who created the first and second chat rooms, or a user with management authority over the chat room group.

However, in the present disclosure, the first and second chat rooms are not limited to belonging to the same chat room group. In some cases, the first and second chat rooms may be individual chat rooms not belonging to the same chat room group. In this case, the first terminal 20 may be an administrator terminal for each of the first and second chat rooms.

The server 10 may provide a reaction custom interface to the first terminal 20, so that the first terminal 20 can receive reaction custom information from the user of the first terminal 20. Through the reaction custom interface, the first terminal 20 may display a list of all selectable reaction information items and receive selection information on an individual reaction information item to include in a custom reaction set.

In some cases, the server 10 may provide a reaction information item generating function to the first terminal 20. The reaction information item generating function refers to a function of generating a new reaction information item based on graphic information provided from the first terminal 20 to the server 10. The first terminal 20 may provide graphic information held by the first terminal 20 to the server 10 and request the server 10 to generate a new reaction information item representing the user's preferences, tastes, or personality. The graphic information may be, for example, character images, symbol images, logo images, and color patterns related to the user of the first terminal 20. When any new reaction information item is generated using the reaction information item generating function, the newly generated reaction information item may be added to the list of selectable reaction information items on the reaction custom interface.

The number of individual reaction information items to be included in the custom reaction set may be limited. For example, the number of individual reaction information items to be included in a custom reaction set may be set to a minimum of 1 and a maximum of 7. In some cases, no individual reaction information item may be selected for inclusion in a custom reaction set (0 selection) and a reaction function may not be provided for content posted in a corresponding chat room.

Each individual reaction information item to be included in a custom reaction set may contain order information. When any individual reaction information item is provided and displayed on the second user terminal in operation 205 or 207, the individual reaction information item may be displayed at a position specified based on the order information. The order information for each individual reaction information item may be determined based on information specified by the server 10 for a corresponding individual reaction information item, or the order information of each individual reaction information item may be specified by the first terminal 20 based on an input from the user.

In addition, the first terminal 20 may receive, from the user, designation information specifying a chat room where reaction custom information is to be applied. Specifically, the first terminal 20 may display a list of all chat rooms where reaction custom information can be set, and receive designation information specifying a chat room where the reaction custom information is to be applied.

The first terminal 20 may generate reaction custom information, including selection information on an individual reaction information item and designation information specifying a chat room, and transmit the reaction custom information to the server 10.

In some cases, the first terminal 20 may generate reaction custom information in advance, including selection information on an individual reaction information item and designation information specifying a chat room, and store the reaction custom information on the server 10 or the first terminal 20. Later, as needed, the stored reaction custom information may be selected (loaded) and transmitted to the server 10.

When the first terminal 20 intends to apply the same reaction custom information to a plurality of chat rooms, the first terminal 20 may select (load) and use previously stored reaction custom information without needing to repeatedly input selection information on each individual reaction information item in each chat room, thus increasing convenience.

In operation 203, the server 10 generates first and second reaction sets, each including at least one reaction information item selected based on a corresponding one of the first and second reaction custom information.

When the server 10 receives reaction custom information from the first terminal 20 in operation 201, the server 10 may generate a reaction set based on the reaction custom information. The reaction set may include at least one reaction information item based on selection information included in the reaction custom information.

The first and second reaction sets generated by the server 10 may be provided to the first terminal 20 in a similar or identical form as provided to the second terminal 30 in subsequent operation 205 or 207. The first terminal 20 may check the first and second reaction sets generated and provided by the server 10 and request to apply the first and second reaction sets to the first and second chat rooms.

If each of the first and second reaction custom information includes different selection information on individual reaction information items, the first and second reaction sets are generated differently. Specifically, each of the first and second reaction sets may include a distinct combination of reaction information items. In some cases, the first and second reaction sets may have the same combination of reaction information items with different orders in which the reaction information items are displayed.

In some cases, there may be a third chat room belonging to the same chat room group as the first and second chat rooms. The server 10 may not receive separate reaction custom information for the third chat room from the first terminal 20. In this case, the server 10 may set the default reaction set to be a reaction set for the third chat room.

In operation 205, when the second terminal 30 enters a first chat room, the server 10 provides the second terminal 30 with at least one first content posted in the first chat room and a first reaction set.

The server 10 may provide the second terminal 30 with an entry path for entering the first and second chat rooms. When the first and second chat rooms belong to the same chat room group, the second terminal 30 may enter the first and second chat rooms after entering the chat room group. Specifically, upon entering the chat room group, the second terminal 30 may receive from the server 10 a list of chat rooms available for entry within the chat room group. In response to receiving selection information on any one chat room from the list of chat rooms available for entry, the second terminal 30 may enter the selected chat room.

Without joining the first and second chat rooms, the second terminal 30 may enter the first and second chat rooms as a guest to view content posted therein. However, in some cases, the second terminal 30 may be required to join the first and second chat rooms to view content posted therein. In some cases, while the second terminal 30 may be able to enter and view posted content in the first and second chat rooms without joining, joining the first and second chat rooms may be necessary to leave a reaction to the content.

The second terminal 30 may join the first and second chat rooms individually. However, in some cases, if the first and second chat rooms belong to the same chat room group, the second terminal 30 may join the chat room group instead of joining the first and second chat rooms individually.

When the second terminal 30 enters the first chat room, the server 10 may provide information related to the first chat room to the second terminal 30. Specifically, the server 10 may provide the second terminal 30 with at least one first content posted in the first chat room and a first reaction set.

A first content may be a message posted by a participant in the first chat room, an administrator of the first chat room, or the server 10 through the first chat room. The first content may include message information, post information, image information, multimedia information, link information, survey information, voting information, attached files, etc. requested by a participant for posting. The first content may be any type of information transmittable over a network and are not limited to specific types. In the first chat room, one or more first contents may be posted and displayed in chronological order based on when the first contents were posted. Specifically, the most recently posted message in the first chat room may be displayed at the bottom.

The first reaction set may be provided corresponding to each individual first content. When there is a plurality of first contents, the first reaction set may be displayed at a position corresponding to each of the plurality of first contents. For example, the first reaction set may be positioned under each of the plurality of first contents, ensuring that the user of the second terminal 30 can easily recognize that the first reaction set corresponds to a corresponding content.

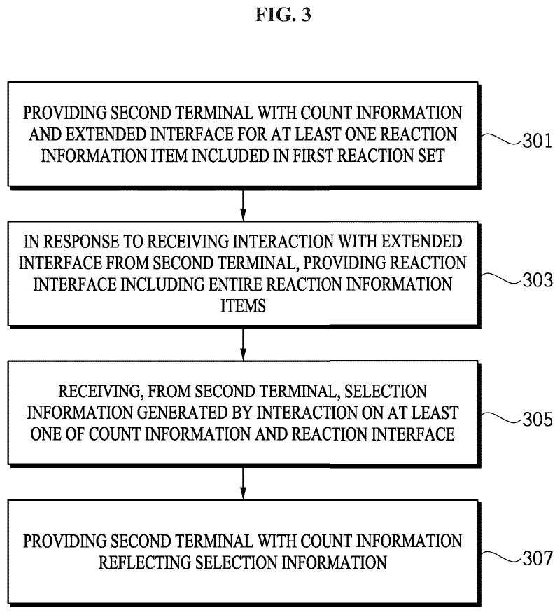

In providing the first reaction set to the second terminal 30, the server 10 may provide count information for a reaction information item and an interface through which an interaction with the reaction information item can be input. This will be explained in detail with reference to FIG. 3 below.

In operation 207, when the second terminal 30 enters the second chat room, the server 10 provides the second terminal 30 with at least one second content posted in the second chat room and a second reaction set.

When the second terminal 30 enters the second chat room, the server 10 may provide information related to the second chat room to the second terminal 30. Specifically, the server 10 may provide the second terminal 30 with at least one second content posted in the second chat room and a second reaction set.

A second content may be a message posted by a participant in the second chat room, an administrator of the second chat room, or the server 10 through the second chat room. The second reaction set may be provided corresponding to each second content. Since specific characteristics of the second content and the second reaction set are similar to those of the first content and the first reaction set, detailed descriptions thereof will be omitted.

Through operations 205 and 207, the server 10 may provide the second terminal 30 with different custom reaction sets (first and second reaction sets) to the first and second chat rooms, respectively. Because each custom reaction set includes a distinct combination of reaction information items, the user of the second terminal 20 may receive different reaction information items in each chat room, without any duplication. In addition, the first terminal 20 may provide the most suitable combination of reaction information items selected based on a subject, theme, purpose, or topic of a chat room, thereby enhancing the effectiveness of communication through reactions.

In operation 209, the server 10 receives, from the second terminal 30, selection information on a reaction information item included in the first or second reaction set.

The user of the second terminal 30 may view the first or second content posted in the first or second chat room and leave a reaction. To this end, the second terminal 30 receives, from the user, an interaction of selecting a reaction information item included in the first or second reaction set and provides selection information on the reaction information item to the server 10.

The second terminal 30 may receive an interaction regarding selection of a reaction information item in various ways. This will be explained in detail with reference to FIG. 3 below.

FIG. 3 is a flowchart for explaining some operations included in a method for providing a reaction set for content by the server 10 of the present disclosure.

Referring to FIG. 3, a process of providing an interface for a reaction set and receiving selection information, performed between the server 10 and the second terminal 30, will be described.

Operations 301 and 303 of FIG. 3 correspond to detailed operations included in operation 205 of FIG. 2. In addition, operation 305 of FIG. 3 corresponds to a specific example of operation 209 of FIG. 2.

In operation 301, the server 10 provides the second terminal 30 with count information and an extension interface for a reaction information item.

The count information for a reaction information item refers to information on the number of reactions left by a user who has viewed a corresponding content. The server 10 may provide count information for all reaction information items included in a first reaction set, or may provide count information for only some of the reaction information items included in the first reaction set.

When the server 10 provides count information for only some of the reaction information items included in the first reaction set, reaction information items for which count information is to be provided may be selected based on various criteria. In one embodiment, reaction information items for which count information is to be provided may be selected based on the number of counts of each corresponding reaction information item. For example, count information may only be provided for any reaction information item with counts of 5 or higher.

In another embodiment, reaction information items for which count information is to be provided may be selected based on a predetermined number. For example, four reaction information items with highest counts may be selected to be provided with count information.

In yet another embodiment, reaction information items for which count information is to be provided may be reaction information items specified in advance by the first terminal 20 or the server 10. By specifying some of the reaction information items included in the first reaction set, the first terminal 20 or the server 10 may set the specified reaction information items to be displayed with count information, regardless of counts for the reaction information items.

When the server 10 provides a plurality of count information to the second terminal 30, the order of the plurality of count information to be displayed on the second terminal 30 may be determined based on various predetermined criteria. For example, the plurality of count information may be displayed in descending order of counts. In addition, the plurality of count information may be displayed based on distinct order information of each reaction information item.

The extension interface refers to an interface for displaying all reaction information items included in the first reaction set. When there is a plurality of reaction information items included in the first reaction set, the server 10 may not immediately provide the entire reaction information items to the second terminal 30 but may provide the extension interface. When the server 10 receives an interaction with the extension interface from the second terminal 30, the server 10 may provide the entire reaction information items to the second terminal 30.

In some cases, when the server 10 provides count information for the entire reaction information items included in the first reaction set in operation 301, the extension interface may not be provided.

In operation 303, when the server 10 receives an interaction with the extension interface from the second terminal 30, the server 10 provides a reaction interface containing the entire reaction information items.

As described above, when the server 10 receives an interaction with the extension interface from the second terminal 30 in operation 301, the server 10 may provide the entire reaction information items to the second terminal 30. Here, the entire reaction information items may be provided in the form of interfaces through which the user of the second terminal 30 can input a selection of an individual reaction information item.

In operation 305, the server 10 receives, from the second terminal 30, selection information generated by an interaction with at least one of count information and a reaction interface.

After viewing a content, the user of the second terminal 30 may input a selection interaction to select a reaction information item. In the second terminal 30, the selection interaction may be input in various ways.

Specifically, the selection interaction may correspond to at least one of an interaction with count information and an interaction with a reaction interface provided through the extension interface. When a reaction information item that the user of the second terminal 30 wishes to select is displayed with count information, the user of the second terminal 30 may input an interaction with the corresponding count information. However, when the reaction information item that the user of the second terminal 30 wishes to select is not displayed with count information, or when the user of the second terminal 30 wishes to select a reaction information item after checking the entire reaction information items, the second terminal 30 may receive a reaction interface including the entire reaction information items through the extension interface and input an interaction with an individual reaction information item included in the reaction interface.

In operation 307, the server 10 provides the second terminal 30 with count information reflecting the selection information.

When the server 10 receives the selection information from the second terminal 30, the server 10 may increase the counts of a corresponding reaction information item. The server 10 may provide the second terminal 30 with count information reflecting an increase in the counts, so that updated count information can be displayed on the second terminal.

In some cases, by inputting an interaction with an already selected reaction information item, the second terminal 30 may cancel the selection of the corresponding reaction information item. When such a cancellation interaction is received, the server 10 may decrease the counts of the corresponding reaction information item.

In some cases, joining a chat room may be required to input an interaction to select a reaction information item in the chat room. Joining a chat room may be distinct from viewing the chat room. Specifically, there may be open chat rooms where users can enter and leave reactions without a separate registration process, as well as join-required chat rooms where users can view content upon entry but need to join to leave reactions.

If a chat room requires joining and the second terminal 30 belongs to a user who has not joined a corresponding chat room group, the server 10 may subsequently provide guidance information on joining the chat room to the second terminal 30 in response to operation 305. The guidance information on joining the chat room may refer to joining the chat room or joining a chat room group to which the chat room belongs.

The above-described operations 301 and 303 have been described on the premise that the second terminal 30 has entered the first chat room. However, in some cases, the second terminal 30 may have entered the second chat room, and in such cases, substantially the same processes as described in operations 301 and 303 may be performed.

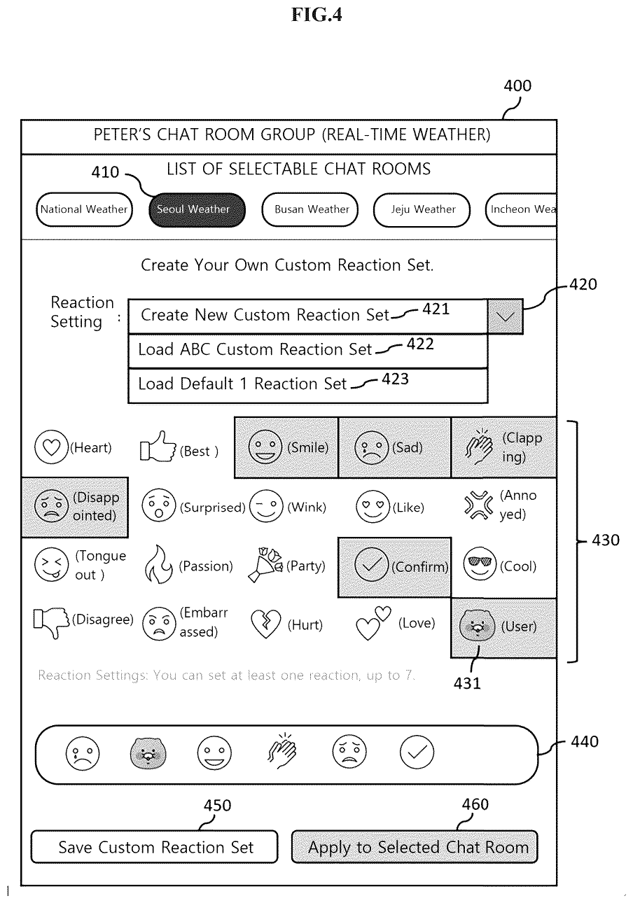

Hereinafter, a method for providing a custom reaction input interface by the user terminal 10, as described in FIG. 1, will be described with reference to FIGS. 4 to 9.

FIG. 4 illustrates a screen 400 of the first terminal 20 related to performing operation 201 of FIG. 2.

Referring to FIG. 4, the first terminal 20 may display an interface for inputting reaction custom information for a chat room, and input an interaction with the interface to input the reaction custom information for the chat room.

The first terminal 20 may display a selectable chat room list interface and receive an interaction of selecting at least one chat room 410 where the reaction custom information is to be applied. Although FIG. 4 shows an example where a single chat room is selected, it is possible to select two or more chat rooms simultaneously and apply the same custom reaction information to the two or more chat rooms.

The first terminal 20 may provide options for reaction setting for a selected chat room. The options for reaction setting may be provided in the form of a dropdown menu 420.

For example, the options for reaction settings on the first terminal 20 may include an option 421 to create a new custom reaction set, an option 422 to load an prestored custom reaction set, and an option 423 to load a default reaction set.

Although FIG. 4 shows an example an option to load an existing custom reaction set and an operation to load a default reaction set are provided separately, if there is a plurality of pre-stored custom reaction sets, an option to select any one of the plurality of pre-stored custom reaction sets may be provided. Similarly, if there is a plurality of default reaction sets, an option to select any one of the plurality of default reaction sets may be provided.

In FIG. 4, the option 421 to create a new custom reaction set is selected. The first terminal 20 may display the entire set of selectable individual reaction information items and receive selection information on an individual reaction information item to be included in a custom reaction set. In FIG. 4, six individual reaction information items (shaded) are selected to be included in the custom reaction set for the chat room named “Seoul Weather.”

One of the selectable reaction information items may be a user-generated reaction information item 431 generated based on graphic information provided by the first terminal 20 to the server 10. Before displaying the screen 400 of FIG. 4, the first terminal 20 may have requested a function to transmit the graphic information to the server 10, so that the user-generated reaction information item 431 is generated and selected to be included in the custom reaction set.

In FIG. 4, a reaction information item selected by the user of the first terminal 20 may be displayed in a separate area 440. The user of the first terminal 20 may change the order of selected reaction information items. Specifically, the user of the first terminal 20 may change the order of reaction information items by dragging each individual reaction information item within the area 440.

In another embodiment, the user of the first terminal 20 may directly input a sorting order for the reaction information items displayed in the area 440. Here, the order of the reaction information items may be changed by various ways, including dragging each individual reaction information item or directly inputting a sorting order therefor.

Once the order of the reaction information items is determined by the above-described method, the second terminal 30 may display the reaction information items based on the determined order. For example, the second terminal 30 may display a plurality of reaction information items sorted in a left-right direction based on the determined order. In some cases, the second terminal 30 may display the reaction information items in the determined order before count information for the reaction information items is accumulated (i.e., in a case where the count is 0). After the count information is accumulated, the display order of the reaction information items may be changed based on the count information.

When an interface 450 is selected after selection of reaction information items to be included in the custom reaction set is completed, the custom reaction set may be saved separately and later applied to other chat rooms using a loading function. When an interface 460 is selected after selection of reaction information items to be included in the custom reaction set is completed, the custom reaction set may be applied to a designated chat room 410.

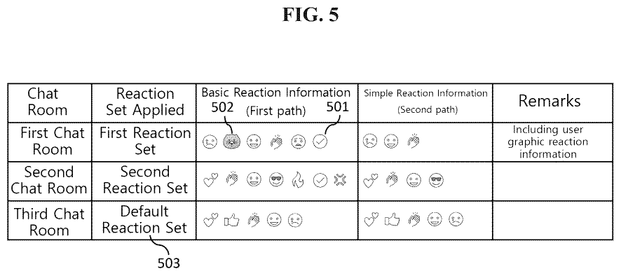

Although not shown in the drawing, the first terminal 20 may provide various setting functions related to displaying a reaction set. For example, as shown in FIG. 5, the first terminal 20 may provide a setting function to determine whether to activate different reaction sets based on an entry path of the second terminal 30 into the chat room. In addition, the first terminal 20 may provide a function to set a reaction set not to be displayed in the chat room.

FIG. 5 illustrates a table showing a database related to the execution of operation 203 of FIG. 2.

The server 10 may generate at least one reaction set to be applied to a chat room in response to operation 203. The reaction set may include at least one reaction information item.

The server 10 may provide a plurality of paths for the second terminal 30 to enter a chat room. The server 10 may provide a different reaction set depending on a path through which the second terminal 30 has entered a chat room. Referring to FIG. 5, when the second terminal 30 enters a first chat room through a first path, six reaction information items may be provided. On the other hand, when the second terminal 30 enters the first chat room through a second path, three reaction information items may be provided.

Here, the first path and the second path may correspond to entries via different applications installed on the second terminal 30. If the server 10 provides two different applications that allow entry to the same chat room, the first and second paths may be determined based on which applications are used to enter the chat room.

In some cases, the first and second paths may vary depending on how the second terminal 30 enters a chat room. For example, if the second terminal 30 enters a chat room via a chat-related application, this entry may correspond to the first path, and if the second terminal 30 enters the chat room via a web browser, this entry may correspond to the second path.

In some cases, the first and second paths may vary depending on a display mode of terminal 30. For example, even if the second terminal 30 enters a chat room via a web browser, the first and second paths may be distinguished based on whether the web browser is set to PC mode or mobile mode.

As illustrated in FIG. 5, for a single reaction set, a basic combination of reaction information items (basic reaction information) may be set to be provided upon entry via the first path, while a simple combination of reaction information items (simple reaction information) may be set to be provided upon entry via the second path. The simple combination of reaction information items may correspond to at least part of the basic combination of reaction information items.

The simple reaction information may be determined based on various criteria related to the basic reaction information. For example, in some cases, the simple reaction information may be determined by excluding at least one reaction information item from the entire reaction information items. For example, if a reaction information item 501 is not supported in the simple reaction set, the reaction information item 501 may be excluded from the simple reaction set. In addition, if a user graphic reaction information item 502 is not supported in the simple reaction set, the user graphic reaction information item 502 may be excluded from the simple reaction set.

In another example, the simple reaction information may be determined based on the number of reaction information items included. Although different numbers of reaction information items are shown in the example in FIG. 5, in some cases, simple reaction information may be determined by a criterion that allows the simple reaction information to include up to 4 reaction information items.

As illustrated in the example of FIG. 5, basic reaction information and simple reaction information may also be set identically.

In the example of FIG. 5, where one reaction set varies depending on a path, a relationship between basic reaction information and simple reaction information has been explained. However, in some cases, a relationship between basic reaction information and extended reaction information may be set. Unlike the simple reaction information, the extended reaction information may include more reaction information items than the basic reaction information.

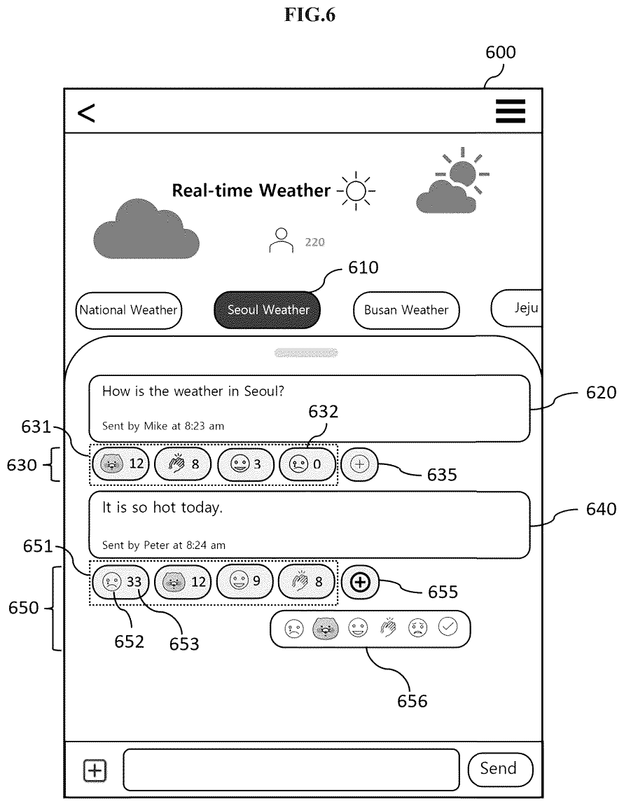

FIG. 6 illustrates a screen 600 of the second terminal 30 related to performing operation 205 of FIG. 2.

Referring to FIG. 6, the second terminal 30 has entered the “Seoul Weather” chat room, which corresponds to the first chat room. The second terminal 30 displays a plurality of contents 620 and 640 posted in the first chat room and a first reaction set 630 and 650 corresponding to each of the plurality of contents.

Each of the first reaction sets 630 and 650 shows count information 631 and 651 and extension interfaces 635 and 655 for reaction information items.

In the example of FIG. 6, the count information shows only the count information for four reaction information items with the highest counts among the entire reaction information items included in the first reaction set, ordered by count in descending order. Since the four reaction information items with the highest counts are selected from the entire reaction information items, a reaction information item with a count of 0 may be selected and count information 632 therefor may be displayed. The count information may include image information 652 of the corresponding reaction information item and content count information 653 for the corresponding reaction information item.

When the second terminal 30 receives an interaction input for the extension interface 655, a reaction interface 656 including the entire reaction information items included in the first reaction set may be displayed.

If a user of the second terminal 30 wishes to input a reaction to the content 640, the user of the second terminal 30 may interact with an individual reaction information item displayed in the count information 651 and the reaction interface 656.

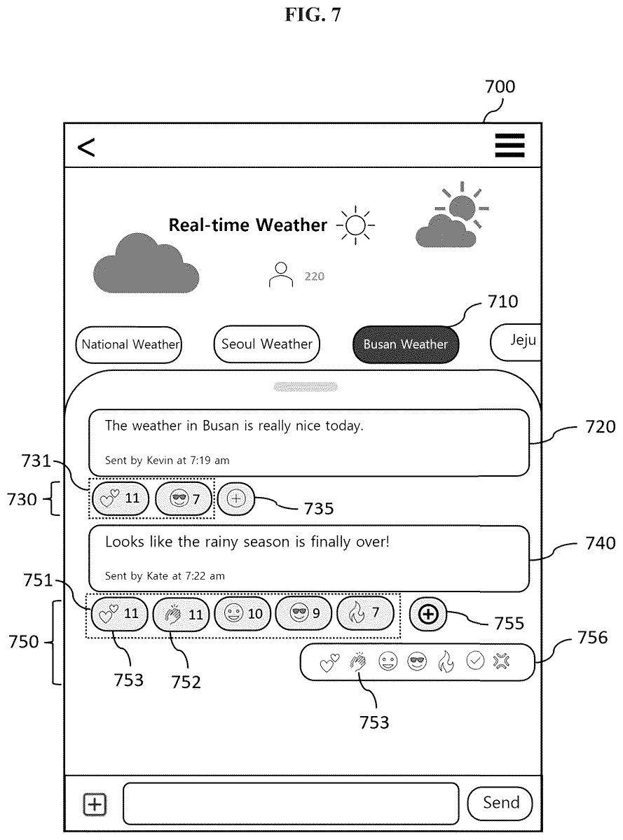

FIG. 7 illustrates a screen 700 of the second terminal 30 related to performing operation 207 of FIG. 2.

Referring to FIG. 7, the second terminal 30 has entered the “Busan Weather” chat room corresponding to the second chat room. The second terminal 30 displays a plurality of contents 720 and 740 posted in the second chat room and displays second reaction sets 730 and 750 respectively corresponding to the plurality of contents 720 and 740.

Each of the second reaction sets 730 and 750 shows count information 731 and 751 and extension interfaces 735 and 755 for reaction information items.

In the example of FIG. 7, the count information shows only reaction information items each having a count equal to or greater than a predetermined value (e.g., 5 or more in the example of FIG. 7) among the entire reaction information items included in the second reaction set. In this case, the number of count information provided for each of the reaction sets 730 and 750 may vary. In the example of FIG. 7, the count information 731 for two reaction information items and the count information 751 for five reaction information items are shown.

In the example of FIG. 7, the count information is displayed in descending order of count. Referring to count information 752 and count information 753, it is shown that the count information 753 with the same count of 11 is displayed first (on the right).

When the second terminal 30 receives an interaction with the extension interface 755, a reaction interface 756 including the entire reaction information items included in the second reaction set may be displayed.

If the user of the second terminal 30 wishes to input a reaction to the content 740, the user of the second terminal 30 may interact with an individual reaction information item displayed in the count information 751 and the reaction interface 756.

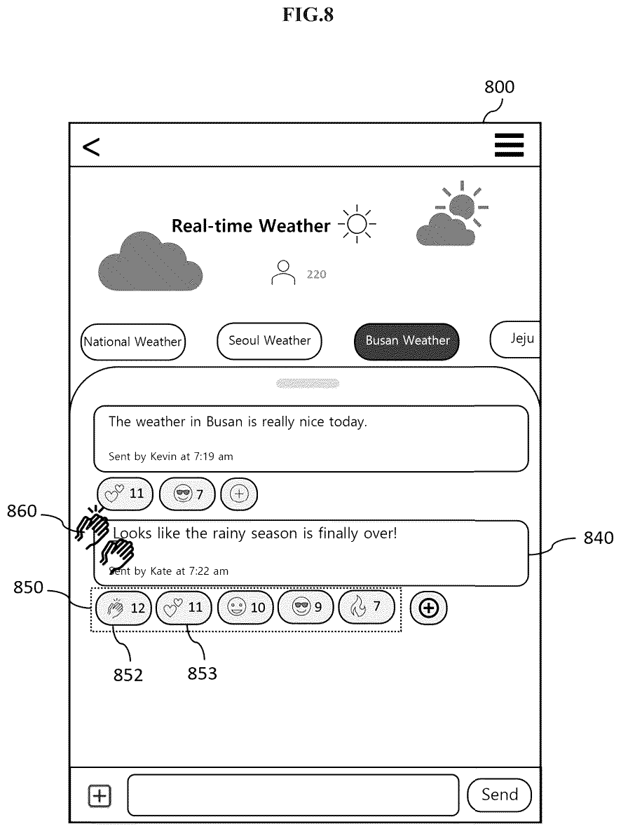

FIG. 8 illustrates a screen 800 of the second terminal 30 related to performing operation 209 of FIG. 2.

FIG. 8 illustrates a screen of the second terminal 30 in a case where an interaction with either the count information 752 or the reaction interface 753 is input on the screen 700 in FIG. 7.

When the reaction information item 753 is selected, the count of the count information 752 for the reaction information item 753 increases by 1. Referring to FIG. 8, the count of count information 852 changes to 12, and count information 852 is displayed first (on the left) before count information 853. In addition, when a reaction information item 753 is selected, a reaction effect 860 corresponding to the reaction information item 753 is displayed for a target content 840.

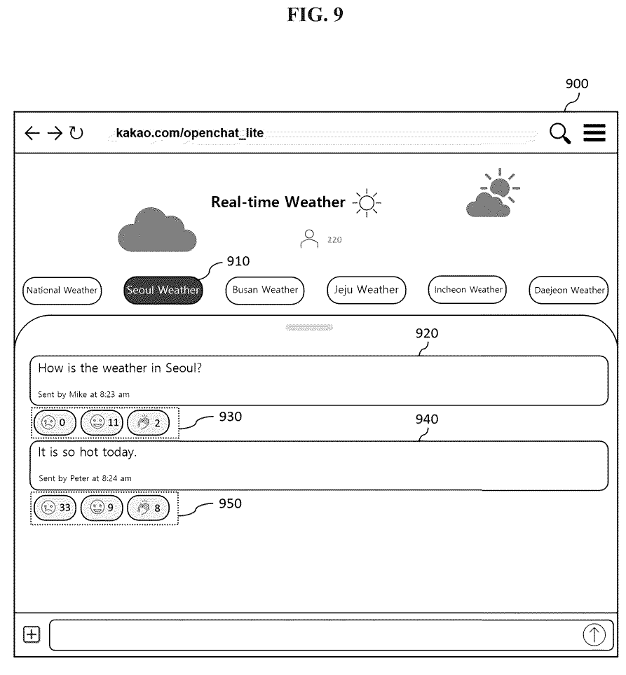

FIG. 9 is a screen 900 of the second terminal 30 related to performing operation 205 of FIG. 2 in a case where the second terminal 30 has entered the first chat room through a different path than in FIG. 6.

Specifically referring to FIG. 9, the second terminal 30 has entered the first chat room via a web browser. An entry path via an application like in FIG. 6 corresponds to the first path described in operation 205, while an entry path via a web browser like in FIG. 9 correspond to the second path described in operation 205.

Comparing FIGS. 6 and 9, even if the second terminal 30 enters the first chat room through a second path, first contents 920 and 940 posted in the first chat room may be displayed in the same manner as when entering through the first path of operation 205.

Referring to FIG. 9, the server 10 provides simple reaction information items for a first reaction set to the second terminal 30. Therefore, although the basic reaction information items for the first reaction set includes a total of six reaction information items, only three reaction information items 930 and 950 corresponding to the simple reaction information items are provided.

The manner in which a reaction set is displayed may vary depending on an entry path used by the second terminal 30 to enter the first chat room. Referring to FIG. 9, instead of displaying count information and extension interfaces for some reaction information items included in a reaction set, count information for all the reaction information items included in the reaction set is displayed. In addition, the count information for the reaction information items is displayed according to a predetermined order of reaction information items rather than in descending order of count.

While the displayed reaction information may vary depending on whether the second terminal 30 has entered the chat room through the first path or the second path, counts of the reaction information items may be displayed consistently regardless of the entry path into the chat room.

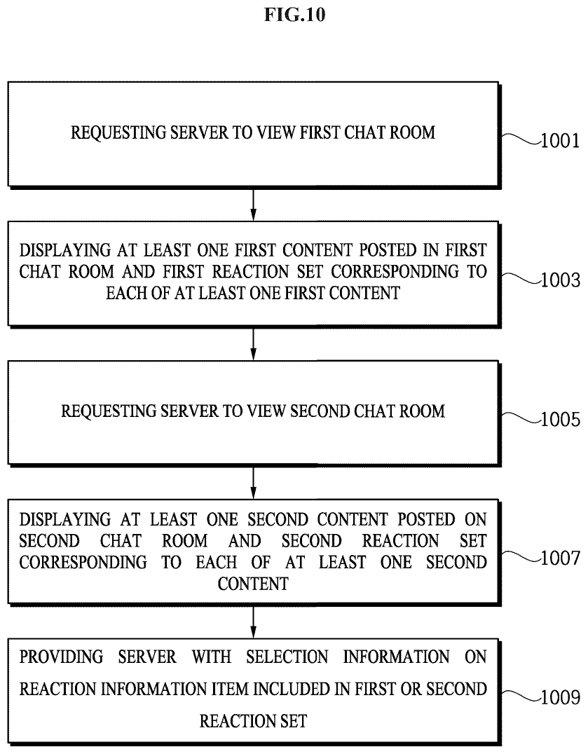

Hereinafter, a method for displaying a reaction set for content by the second terminal 30 of the present disclosure will be described with reference to FIG. 10.

The method of providing a reaction set for content by the second terminal 30, as described in FIG. 10, is substantially similar to the method described in FIGS. 2 to 9 for the server 10 to provide a reaction set for content. Therefore, for convenience of explanation, some of the description already provided above with reference to FIGS. 2 to 9 will be omitted.

FIG. 10 is a flowchart for explaining a method for providing a reaction set for content by the second terminal 30 of the present disclosure.

In operation 1001, the second terminal 30 requests to view the first chat room from the server 10. Operation 1001 corresponds to an operation immediately preceding operation 205 of FIG. 2.

In operation 1003, the second terminal 30 displays at least one first content posted in the first chat room and a first reaction set corresponding to each of the at least one first content. Operation 1003 corresponds to operation 205 of FIG. 2.

In operation 1005, the second terminal 30 requests to view the second chat room from the server 10. Operation 1005 corresponds to an operation immediately preceding operation 207 of FIG. 2.

In operation 1007, the second terminal 30 displays at least one second content posted in the second chat room and a second reaction set corresponding to each of the at least one second content. Operation 1007 corresponds to operation 207 of FIG. 2.

In operation 1009, the second terminal 30 provides the server 10 with selection information on a reaction information item included in the first or second reaction sets. Operation 1009 corresponds to operation 209 of FIG. 2.

According to the present disclosure, it is possible to provide a method for providing a custom reaction sets by a server to a terminal entering a chat room.

In addition, it is possible to provide a method for conveniently selecting a reaction information item by a terminal entering a chat room.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing a reaction set for content by a server, the method comprising:
receiving first reaction custom information for a first chat room from a first terminal;
generating a first reaction set including at least one reaction information item selected based on the first reaction custom information;
in response to a second terminal entering the first chat room, providing the second terminal with at least one first content posted in the first chat room and a first reaction set corresponding to each of the at least one first content; and
receiving selection information on a reaction information item included in the first reaction set from the second terminal.

2. The method of claim 1, further comprising:
receiving second reaction custom information for a second chat room from the first terminal;
generating a second reaction set including at least one reaction information item selected based on the second reaction custom information, where each of the first and second reaction sets includes a distinct combination of reaction information items;
in response to the second terminal entering the second chat room, providing the second terminal with at least one second content posted in the second chat room and a second reaction set corresponding to each of the at least one second content; and
receiving selection information on a reaction information item included in the second reaction set from the second terminal.

3. The method of claim 1, further comprising, in response to the second terminal entering a third chat room when no separate reaction custom information for the third chat room is received from the first terminal, providing the second terminal with at least one third content posted in the third chat room and a default reaction set corresponding to each of the at least one third content.

4. The method of claim 1, wherein providing the first or second reaction set comprises:
providing the second terminal with count information and an extension interface for at least one reaction information item included in the first or second reaction set, wherein the count information indicates information on a number of times a user has selected the reaction information item; and
in response to receiving an interaction with the extension interface from the second terminal, providing a reaction interface including entire reaction information items included in the first or second reaction set.

5. The method of claim 4, wherein the count information is provided only for a reaction information item of which a count satisfies a predetermined criterion among the reaction information items included in the first or second reaction set.

6. The method of claim 4, wherein the selection information is generated in response to an interaction received by the second terminal with at least one of the count information and the reaction interface.

7. The method of claim 1, further comprising generating a 1a-th reaction set including at least one of the reaction information items included in the first reaction set,
wherein the server provides the second terminal with first and second paths to enter the first chat room, and
wherein in providing the first reaction set, the first reaction set is provided to the second terminal when the second terminal enters the first chat room through the first path, and the 1a-th reaction set instead of the first reaction set is provided to the second terminal when the second terminal enters the first chat room through the second path.

8. The method of claim 7, wherein the first and second paths correspond to entries via different applications installed on the second terminal.

9. The method of claim 1, wherein at least one of the reaction information items included in the first and second reaction sets is generated based on graphic information received by the server from the first terminal.

10. The method of claim 1, wherein:
the first and second chat rooms belong to a same chat room group, and
the first terminal corresponds to an administrator terminal for the chat room group.

11. The method of claim 10, further comprising, immediately after receiving the selection information, providing second terminal with guidance information on joining the chat room group when the second terminal belongs to a user who has not joined the chat room group.

12. A server for providing a reaction set for content, the server comprising:
a memory storing instructions, and
a processor configured to execute the instructions to:
receive first reaction custom information for a first chat room from a first terminal;
generate a first reaction set including at least one reaction information item selected based on the first reaction custom information;
in response to a second terminal entering the first chat room, provide the second terminal with at least one first content posted in the first chat room and a first reaction set corresponding to each of the at least one first content; and
receive selection information on a reaction information item included in the first reaction set from the second terminal.

13. A method for displaying a reaction set for content by a terminal, the method comprising:
requesting the server to view a first chat room;
displaying at least one first content posted in the first chat room and a first reaction set corresponding to each of the at least one first content, the first reaction set including at least one reaction information item;
requesting the server to view a second chat room;
displaying at least one second content posted in the second chat room and a second reaction set corresponding to each of the at least one second content, the second reaction set including at least one reaction information item; and
providing the server with selection information on a reaction information item included in the first or second reaction set,
wherein different combinations of reaction information items are included in the first and second reaction sets.

14. The method of claim 13, wherein displaying the first or second reaction set comprises:
displaying count information and an extension interface for at least one of the reaction information items included in the first or second reaction set, wherein the count information is information on a number of times a user has selected the reaction information item; and
in response to receiving an interaction with the extension interface, displaying a reaction interface including entire reaction information items included in the first or second reaction set.

15. The method of claim 14, wherein the count information is provided only for a reaction information item of a count satisfies a predetermined standard among the reaction information items included in the first or second reaction set.

16. The method of claim 14, wherein the selection information is generated in response to an interaction with at least one of the count information and the reaction interface.

17. The method of claim 13, wherein:
in requesting to view the first chat room, the terminal requests to view the first chat room through any one of first and second paths, and
in displaying the first reaction set, the first reaction set is displayed when the terminal requests to view the first chat room through the first path, and a 1a-th reaction set including at least one of the reaction information items included in the first reaction set is displayed instead of the first reaction set when the terminal requests to view the first chat room through the second path.
